(19) United States
(12) Patent Application Publication
(10) Pub. No.: US 2011/0274482 A1
(43) Pub. Date: Nov. 10, 2011

(54) Coupler

(75) Inventor: Dominic Fortin, St-Georges (CA)

(73) Assignee: ESTAMPRO INC., St-Evariste-de-Forsyth (CA)

(21) Appl. No.: 13/100,781

(22) Filed: May 4, 2011

Related U.S. Application Data
(60) Provisional application No. 61/331,646, filed on May 5, 2010.

(51) Int. Cl. F16B 1/00

(52) U.S. Cl. 403/161

(57) ABSTRACT

A universal coupler 10 for coupling an accessory to equipment such that the accessory can rotate about the equipment, the coupler 10 consisting of a fixed attachment 12 for attaching to the equipment, a mobile attachment 14 for attaching to the accessory and which rotates about the fixed attachment, and a rotation system 16 having a drive shaft 38 for rotating the mobile attachment 14. The rotation system 16 includes a rack-and-pinion system which is driven by an actuator 44. The coupler 10 allows for the rapid mounting of a plurality of accessories or implements to the coupler 10, and enables the rotation of the mounted accessory or implement when the coupler 10 is itself mounted to equipment.

### RELATED APPLICATION

This application claims the benefit of U.S. Provisional Application No. 61/331,646, filed on May 5, 2010 and entitled “Coupler”.

The above patent application is incorporated herein by reference in its entirety.

### FIELD OF THE INVENTION

The present invention relates a coupler to be used with handling equipment. More particularly, the present invention relates to a universal coupler for quick attachment of an accessory to a machine.

### BACKGROUND OF THE INVENTION

Different couplers are used for various applications in handling equipment and are known in the art. Generally speaking, these couplers serve as an intermediary for connecting an accessory (such as a shovel, handling equipment, etc.) to a machine (such as a tractor, crane, etc.).

More specifically, known to the Applicant is U.S. Pat. No. 2,945,610 granted to WENDT on Jul. 19, 1960, which describes an industrial lift truck having a system permitting load engaging means to be actuated towards or away from a load which is located either to the left or to the right of the truck in a substantially straight line movement. As well, the invention disclosed pertains to a means for permitting straight-line lateral sliding movement of a load and subsequent swinging of such a load in any desired alternation to the right or to the left. Further provided is a load carrier for trucks movable to any load engaging position with an angle up to 180 degrees without the necessity of remounting the load carrier.

Also known to the Applicant is U.S. Pat. No. 3,659,733 granted to SINCLAIR et al. on May 2, 1972, which describes an attachment for an industrial lift which enables the truck to manipulate loads or pallets in front of and at both sides of the truck without requiring the truck to turn in an aisle. The attachment includes a crossed arm six-bar linkage rotatably mounted on a load-support tree that is attached to a side shifter mechanism. The six-bar linkage allows for the front plate of the lift to be rotated a full 90 degrees to either side of the truck.

Furthermore, U.S. Pat. No. 4,243,356 granted to TAKOJIMA on Jan. 6, 1981, discloses a quick coupler for detachably attaching an implement to an earthworking vehicle.

U.S. Pat. No. 5,779,429 granted to POOLE on Jul. 14, 1998 discloses a quick implement attachment system that utilizes a single coupling unit having two receiving sides interconnected by a longitudinal beam where each receiving side engages a pair of vertically aligned pins mounted on each side of an implement.

As well, U.S. Pat. No. 5,823,270 granted to COOPER on Oct. 20, 1998 discloses a hitch for a machine permitting controlled towing of an implement behind the machine. The hitch has a frame attached to the machine and a subframe mounted to the frame for movement about a first or pivot axis. A mast has a carrier and a hitch element. The carrier is mounted to the subframe for pivotal movement. The hitch element is moveable relative to the carrier and hydraulic cylinders or other control means are provided between the frame and the subframe, the subframe and carrier, and the carrier and hitch element.

Furthermore, U.S. Pat. No. 6,010,080 granted to MARCHAND et al. on Jan. 4, 2000 discloses a device for mounting on a self-propelled vehicle which hydraulically operates the device. This device includes an articulated boom, a boom support on which the articulated boom is mounted, the articulated boom being fixed to the boom support. The equipment is to be mounted at the end of the articulated boom to be raised or lowered. The system includes a hydraulic system that includes a rack and pinion that is used to rotate the boom support about a vertical axis.

Other prior art known to the Applicant include U.S. Pat. Nos. 5,338,148; 5,732,488; and 6,988,560.

Consequently, there is still presently a need for a coupler that can quickly connect an accessory to a machine, while still providing powered rotational motion to the accessory. Although different couplers are already known and satisfy at least one of the above needs, there is still a need for a coupler which will meet a majority, if not all, of the requirements described above.

### SUMMARY OF THE INVENTION

An object of the present invention is to provide a coupler that addresses the above-mentioned needs.

According to the present invention, there is provided a universal coupler for coupling an accessory to equipment such that the accessory can rotate about the equipment. The coupler comprises:
a fixed attachment for attaching to the equipment;
a mobile attachment for attaching to the accessory, the mobile attachment articulating with the fixed attachment so that the mobile attachment is rotatable about the fixed attachment; and
a rotation system having a drive shaft rotatably connecting the fixed attachment to the mobile attachment, the rotation system being configured for rotating the mobile attachment.

Preferably, the present invention allows for the rapid installation and attachment of an accessory such as a shovel, blower, handling equipment, or tool to a machine which manipulates the accessory. The machine can be any one of, but not limited to, a tractor, a crane arm, or a boom.

Preferably, the present invention is universally connectable such that it is able to conform and adapt to the wide variety of hitches or attachments found on accessories and machines. The universality allows the present invention to be used with the many different accessories and machines available.

Preferably, the present invention provides controlled and powered rotation to the accessory. The rotation system described herein allows the accessory to rotate by using an actuated rack-and-pinion device, which allows the accessory to rotate laterally through a range of about 180 degrees. The actuator provides a linear motion which is converted via the rack-and-pinion device into rotational motion. The actuator is selected from a group consisting of, but not limited to, hydraulic cylinders, pneumatic cylinders, and electric motors.

### BRIEF DESCRIPTION OF THE DRAWINGS

These and other objects and advantages of the invention will become apparent upon reading the detailed description and upon referring to the drawings in which:

FIG. 1 is a perspective view of a universal coupler, according to a preferred embodiment of the present invention.

FIG. 2 is a side perspective view of the universal coupler shown in FIG. 1.

### DETAILED DESCRIPTION OF PREFERRED EMBODIMENTS OF THE INVENTION

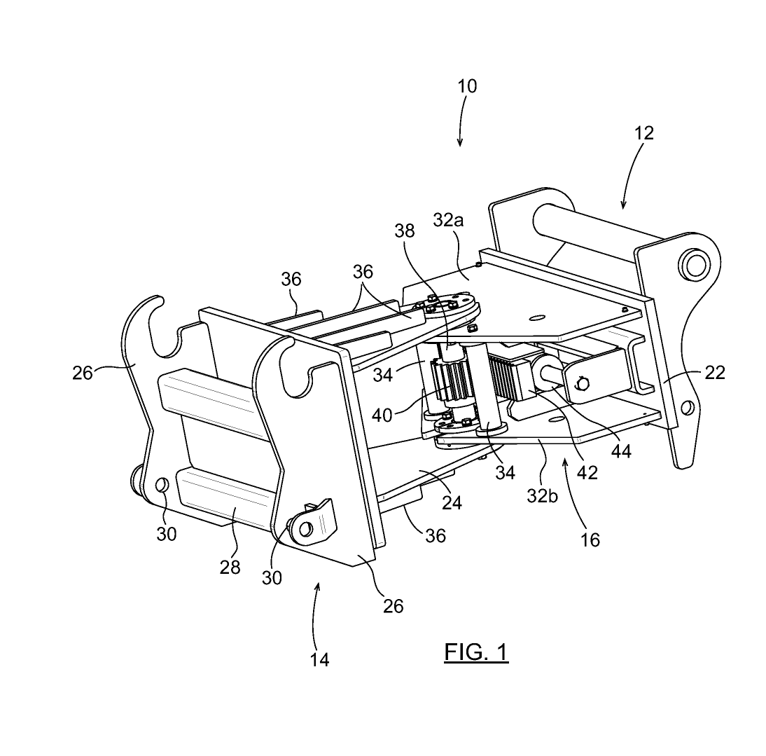

According to the present invention, and as shown in FIG. 1, the universal coupler 10 is composed of a fixed attachment 12, a mobile attachment 14, and a rotation system 16.

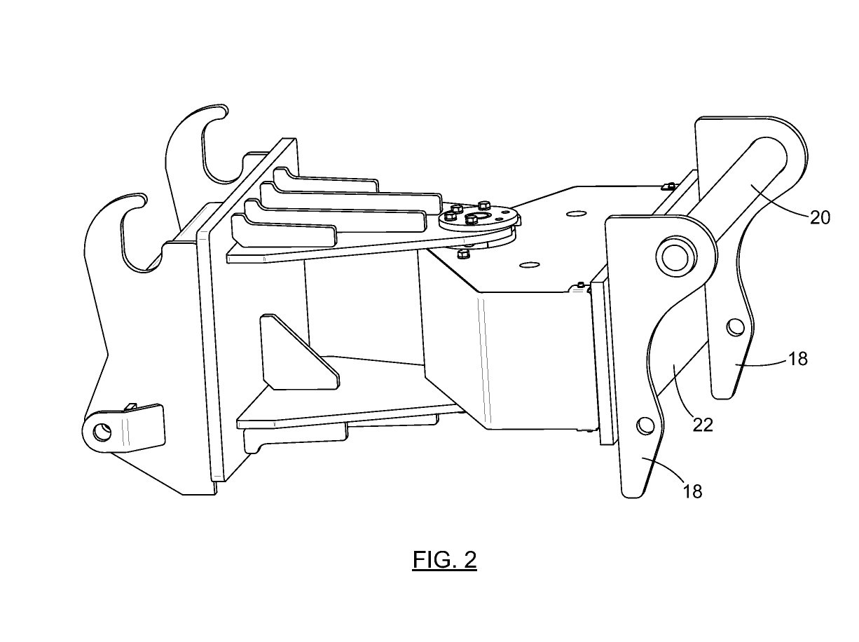

Referring now to FIGS. 1 and 2, the fixed attachment 12 joins the coupler 10 to the machine (not illustrated). The fixed attachment 12 is universal, meaning that it can connect to many different machine connectors so that the coupler 10 can be used on many different types of machines. In a preferred embodiment, the fixed attachment 12 is composed of an equipment attachment mechanism and an interface plate 22, which connects to the equipment attachment mechanism. The fixed attachment 12 also includes a casing with upper and lower plates (32a, 32b). In a preferred embodiment of the invention illustrated in FIGS. 1 and 2, the equipment attachment mechanism is made up of at least two links 18 which anchor to the corresponding attachments of the machine. The links 18 are designed, manufactured and configured to support the weight of the coupler 10 and the accessory that the coupler 10 is joined to. The links 18 are also designed to resist the cyclical stresses associated with the rotation of the accessory, as apparent to a person skilled in the art. However, the specific configuration of the equipment attachment mechanism may vary significantly from one application to another, and be specifically designed for and adapted to the interface through which the coupler 10 will attach to the equipment.

The equipment attachment mechanism shown in the sample embodiment of FIGS. 1 and 2 is also preferably composed of a crossbar 20 which joins the links 18. The crossbar 20 also provides another method for the coupler 10 to be attached to the machine by attaching a mechanical fastener thereto, for example. The fixed attachment 12 preferably has an interface plate 22 onto which the links 18 are securely mounted by means known in the art. Referring now to FIG. 1, the interface plate 22 joins the links 18 to a casing comprising an upper plate 32a and a lower plate 32b. The upper and lower plates (32a,32b) are connected by at least one anti-compression pillar 34 which provides structural support for the plates (32a,32b) against compressive forces and moments that act against the plates (32a,32b) when an accessory is attached to the coupler 10.

Referring now to FIG. 1, the mobile attachment 14 attaches directly to the accessory (not illustrated), and is preferably rotatably connected to the plates (32a,32b) of the fixed attachment 12. The mobile attachment 14 is universal, meaning that it can connect to many different accessory connectors so that the coupler 10 can be used on many different types of accessories. The mobile attachment 14 is configured to rotate about the fixed attachment 12, thus imparting a rotational motion to the accessory to which the mobile attachment 14 is joined. The mobile attachment 14 preferably consists of a platform 24 and an accessory attachment mechanism which is mounted against the platform 24 and which attaches to the accessory.

The platform 24 is rotatably connected to the plates (32a,32b) of the fixed attachment 12 via rotatable fasteners and/or bearings, as apparent to a person skilled in the art. The platform 24 preferably contains ridges 36 for better receiving various handling-equipment accessories, as apparent to a person skilled in the art. The ridges 36 provide additional structural support to the platform 24 which is thus reinforced.

In a preferred embodiment of the invention illustrated in FIGS. 1 and 2, the accessory attachment mechanism consists of supports 26, a slab 28, and notches 30. The at least two supports 26 are mounted to the platform 24 and anchor the attached accessory. The supports 26 are designed, manufactured and configured to support the weight of the accessory. The supports 26 are also designed to resist the cyclical stresses associated with the rotation of the accessory, as apparent to a person skilled in the art. The supports 26 preferably have hooked-shaped upper portions for receiving and retaining a component of the accessory. The transverse slab 28 also serves as another anchoring point for the attachments on the accessory, such as a fastener, and the slab 28 joins the supports 26. Notches 30 in supports 26 allow for a bar from the accessory to be inserted through the notches 30, thus further securing the connection of the coupler 10 with the accessory. However, as was the case for the equipment attachment mechanism, the specific configuration of the accessory attachment mechanism may vary significantly from one application to another, and be specifically designed for and adapted to the interface through which the coupler 10 will attach to the accessory.

Referring now to FIG. 1, the rotation system 16 provides rotational movement to the accessory or to the mobile attachment 14. The rotation system 16 includes a drive shaft 38 which rotatably connects the fixed attachment 12 with the mobile attachment 14. Preferably, the drive shaft 38 joins platform 24 of the mobile attachment 14 with the plates (32a,32b) of the fixed attachment 12. In a preferred embodiment, a pinion gear 40 is fitted around the drive shaft 38. Preferably, when the pinion gear 40 rotates, the drive shaft 38 rotates at the same angular velocity, as apparent to a person skilled in the art. The rotation system also preferably includes a mobile rack 42 having teeth for fitting with the teeth of the pinion gear 40, as apparent to a person skilled in the art. The rack 42 is mounted onto a moveable platform so that it can be displaced in a linear direction, as also apparent to a person skilled in the art.

When the rack 42 is displaced in one linear direction, it imparts a rotational motion to the gear 40, causing the mobile attachment 14 and the attached accessory to rotate in the same direction as the rotation of the gear 40. An actuator 44 is connected to the rack 42 such that the actuator 44 provides controlled linear motion to the rack 42. The actuator 44 is preferably securely mounted to the fixed attachment 12, as apparent to a person skilled in the art. Preferably also, the actuator 44 is double-shafted and is powered by a hydraulic fluid, pneumatic pressure, or an electric motor. As the actuator 44 is displaced in one linear direction, it displaces the attached rack 42. As the actuator 44 retracts or is displaced in an opposite direction, it similarly retracts or displaces the rack 42 in the same direction. In so displacing itself, the actuator 44 transforms its linear motion, via the rack 42, into a rotational motion of the gear 40. Preferably, the transformation of linear motion imparted by the actuator 44 into rotational motion of the gear 40 results in a lateral rotation of the accessory through a range of about 180 degrees.

Preferably, the rotation system 16 is housed within the fixed attachment 12, as illustrated in FIG. 1. Preferably also, the universal coupler 10 is installed on agricultural equipment, like a tractor or a trailer.

Furthermore, the present invention is a substantial improvement over the prior art in that, by virtue of its design and components, the universal coupler 10 is easier to install than what is generally known in the art and is relatively simple and easy to manufacture and/or assemble, without compromising the reliability of its functions. Hence, it may now be appreciated that the present invention represents important advantages over other couplers known in the prior art, in that the coupler 10 according to the present invention allows for the rapid coupling of accessories to machines that power them, irrespective of the various types of connections found on accessories and machines or equipment. The possibility of using the accessories and machines' existing connections greatly reduces the time required to connect and disconnect the accessory.

Indeed, contrary to the couplers of the prior art (ex. U.S. Pat. No. 5,823,270 granted to COOPER), the present coupler 10 provides an inherently less complicated coupler to join accessories to a machines. Moreover, the coupler 10 of the present invention allows for the controlled and motorised (or powered) rotation of the accessory through the use of the rack-and-pinion device, which allows for precise and accurate rotation of the accessory under power. This rotation is also advantageous in that it is effectuated through a range of 180 degrees.

Yet another advantage of the present invention is that its simple design and assembly provides for a durable product which is easily maintained. This increases cost effectiveness for the user of the coupler 10 according to the present invention.

Of course, the scope of the claims should not be limited by the preferred embodiments set forth in the examples, but should be given the broadest interpretation consistent with the description as a whole. Numerous modifications could be made to the above-described embodiments without departing from the scope of the claims, as apparent to a person skilled in the art. Furthermore, it is apparent that this invention can apply to many other uses.

1. A universal coupler for coupling an accessory to equipment such that the accessory can rotate about the equipment, the coupler comprising:
a fixed attachment for attaching to the equipment;
a mobile attachment for attaching to the accessory, the mobile attachment articulating with the fixed attachment so that the mobile attachment is rotatable about the fixed attachment; and
a rotation system having a drive shaft rotatably connecting the fixed attachment to the mobile attachment, the rotation system being configured for rotating the mobile attachment.

2. The coupler according to claim 1, wherein the rotation system comprises:
a pinion gear mountable about the drive shaft for rotating the drive shaft
a mobile rack for rotating the pinion gear; and
an actuator connected to the mobile rack, the actuator being configured for imparting a linear motion to the mobile rack causing the pinion gear to rotate.

3. The coupler according to claim 2, wherein the actuator is selected from the group of mechanical devices for transforming linear motion into rotational motion consisting of hydraulic cylinders, pneumatic cylinders and electric motors.

4. The coupler according to claim 1, wherein the rotation system is housed within the fixed attachment.

5. The coupler according to claim 1, wherein the rotation system laterally rotates the mobile attachment through a range not exceeding 180 degrees.

6. The coupler according to claim 1, wherein the fixed attachment comprises:
an equipment attachment mechanism for attaching to the equipment;
an equipment interface plate for interfacing with the equipment attachment mechanism; and
a casing comprising an upper plate and a lower plate, the upper and lower plates being connectable to the equipment interface plate.

7. The coupler according to claim 2, wherein the fixed attachment comprises:
an equipment attachment mechanism for attaching to the equipment;
an equipment interface plate for interfacing with the equipment attachment mechanism; and
a casing comprising an upper plate and a lower plate, the upper and lower plates being connectable to the equipment interface plate.

8. The coupler according to claim 6, wherein the equipment attachment mechanism comprises:
at least two links for anchoring the fixed attachment to the equipment so as to support a weight of the accessory and the coupler; and
a crossbar for linking the at least two links.

9. The coupler according to claim 6, wherein the upper and lower plates are connectable by at least one anti-compression pillar.

10. The coupler according to claim 7, wherein the upper and lower plates are connectable by at least one anti-compression pillar.

11. The coupler according to claim 1, wherein the mobile attachment comprises:
a platform rotatably mounted about the fixed attachment; and
an accessory attachment mechanism mountable against the platform for attaching to the accessory.

12. The coupler according to claim 2, wherein the mobile attachment comprises:
a platform rotatably mounted about the fixed attachment; and
an accessory attachment mechanism mountable against the platform for attaching to the accessory.

13. The coupler according to claim 6, wherein the mobile attachment comprises:
a platform rotatably mounted about the fixed attachment; and
an accessory attachment mechanism mountable against the platform for attaching to the accessory.

14. The coupler according to claim 11, wherein the accessory attachment mechanism comprises:
at least two supports for anchoring the accessory, each support having a substantially hook-shaped upper portion for securing the accessory, and where each support is mountable against the platform;
a transverse slab for receiving a fastener of the accessory, the transverse slab connecting each support; and
a plurality of notches in the supports for further securing the accessory attachment mechanism to the accessory by receiving a bar of the accessory, the bar spanning between and through opposing notches.

15. The coupler according to claim 11, wherein the accessory attachment mechanism is configured so as to anchor with a plurality of accessories.

16. The coupler according to claim 12, wherein the accessory attachment mechanism is configured so as to anchor with a plurality of accessories.

17. The coupler according to claim 13, wherein the accessory attachment mechanism is configured so as to anchor with a plurality of accessories.

18. The coupler according to claim 14, wherein the accessory attachment mechanism is configured so as to anchor with a plurality of accessories.

19. The coupler according to claim 11, wherein the platform has a plurality of ridges for further reinforcing the platform.

20. The coupler according to claim 12, wherein the platform has a plurality of ridges for further reinforcing the platform.
